(19) United States
(12) Patent Application Publication
(10) Pub. No.: US 2026/0043630 A1
(43) Pub. Date: Feb. 12, 2026

(54) SUPPRESSOR AND METHOD OF MANUFACTURING A SHROUD FOR THE SUPPRESSOR

(71) Applicant: WHG PROPERTIES, LLC, North Wales, PA (US)

(72) Inventors: William H. GEISSELE, Lower Gwynedd, PA (US); Dean DUPREE, Harleysville, PA (US); Frank Eric ROBINSON, Schwenksville, PA (US)

(21) Appl. No.: 18/800,857

(22) Filed: Aug. 12, 2024

(51) Int. Cl. F41A 21/30; B33Y 80/00

(52) U.S. Cl. CPC F41A 21/30; B33Y 80/00

(57) ABSTRACT

A suppressor for a firearm may include an inner casing, an outer casing that circumferentially surrounds at least a portion of the inner casing, and a coupler ring or an end cap. A portion of the coupler ring or the end cap may be positioned radially between the inner casing and the outer casing. The shroud may include a brazed area on the inner casing, the outer casing, the coupler ring, or the end cap.

### TECHNICAL FIELD

The present application relates generally to a suppressor for a firearm and a method of manufacturing a shroud for the suppressor.

### BACKGROUND

Discharging a firearm creates a loud sound that may damage the hearing of a user or otherwise be undesirable and creates a visible flash that may be noticed by others. Suppressors are often attached to a firearm to reduce the sound and/or flash created by the firearm by slowing and cooling the high-pressure gasses that exit the firearm.

The inventors have identified numerous deficiencies and problems with the existing technologies in this field. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include systems, methods, and apparatuses to provide for improved suppressors for firearms and methods of manufacturing shrouds for suppressors.

In various aspects, a method of manufacturing a shroud for a suppressor for a firearm is provided. The method may include welding at least a portion of a coupler ring or at least a portion of an end cap to an inner casing, an outer casing, or both to form an unfinished shroud. The method may include applying a filler metal onto the unfinished shroud. The method may include placing the unfinished shroud into a vacuum chamber. The method may include decreasing a pressure of an environment within the vacuum chamber to less than a threshold. While the unfinished shroud is positioned within the vacuum chamber and while the environment is less than a threshold, the method may include brazing the coupler ring or the end cap with the filler metal to the outer casing, the inner casing, or both. Brazing the coupler ring or the end cap with the filler metal to the outer casing, the inner casing, or both may form a sealed environment between the inner casing and the outer casing.

In various examples, the method includes welding the coupler ring or the end cap to the inner casing and the outer casing, welding the other of the coupler ring or the end cap to the inner casing or the outer casing, brazing the other of the coupler ring or the end cap with the filler metal to the other of the inner casing or the outer casing.

In various examples, the method includes welding the coupler ring or the end cap to the inner casing, the outer casing, or both to form at least one annular weld joint that extends 360 degrees, welding the coupler ring or the end cap to the inner casing or the outer casing to form a partial weld joint that extends less than 360 degrees, and brazing the coupler ring or the end cap to the inner casing or the outer casing to form a braze joint that connects ends of the partial weld joint.

In various examples, the partial weld joint extends at least 320 degrees.

In various aspects, a suppressor for a firearm is provided. The suppressor may define a forward direction, an aft direction, and a linear projectile path. The suppressor may include a shroud. The shroud may include an inner casing, an outer casing that circumferentially surrounds at least a portion of the inner casing, and a coupler ring or an end cap. A portion of the coupler ring or the end cap may be positioned radially between the inner casing and the outer casing. The shroud may include a partial weld joint that extends less than 360 degrees that couples the inner casing or the outer casing to the coupler ring or the end cap. The shroud may include a partial braze joint that extends less than 360 degrees and couples the coupler ring or the end cap to the inner casing or the outer casing. The partial braze joint may connect to ends of the partial weld joint.

In various examples, the coupler ring further comprises an aft portion that is positioned aft of and longitudinally aligned with the inner casing or the outer casing.

In various examples, the coupler ring is configured to seal an environment within a chamber defined between the inner casing and the outer casing.

In various examples, the shroud includes a weld joint that extends 360 degrees that couples the inner casing or the outer casing to the coupler ring or the end cap.

In various examples, the suppressor further comprises an inner body comprising a flange. The flange may define an annular groove, the inner casing may be positioned within the annular groove of the flange, and an aft portion of the coupler ring may be positioned between and longitudinally aligned with the flange and the outer casing.

In various examples, a tortuous path is defined between the shroud and the flange.

In various examples, the tortuous path is configured to allow hot gas to be expelled from within the suppressor to an ambient environment outside of the suppressor.

In various examples, the inner casing, the outer casing, and the coupler ring comprise at least 80 percent titanium.

In various examples, the coupler ring comprises a mid portion that is monolithic with a forward portion and an aft portion, and wherein the forward portion and the aft portion of the coupler ring are cylinder shaped.

In various examples, the inner casing and the outer casing are each cylindrical shaped.

In various examples, the suppressor further comprises an inner body that comprises a plurality of baffles, each baffle defining a baffle opening that is positioned on the linear projectile path.

In various examples, the suppressor further comprises an inner body comprising a flange, the inner casing and the coupler ring define an annular channel, and a rim of the flange is positioned within the annular channel.

In various examples, a thickness of the annular channel is greater than a thickness of the rim of the flange.

In various examples, the shroud comprises the end cap. The end cap may be welded to the inner casing, the outer casing, or both with at least one weld joint that extends 360 degrees.

In various examples, the end cap comprises an annular groove, and wherein the inner casing is positioned within the annular groove of the end cap.

In various aspects, a firearm assembly comprises the suppressor.

In various aspects, a shroud for a suppressor for a firearm is provided. The shroud may include an inner casing, an outer casing that circumferentially surrounds at least a portion of the inner casing, and a coupler ring or an end cap. A portion of the coupler ring or the end cap may be positioned radially between the inner casing and the outer casing. The shroud may include a partial weld joint that extends less than 360 degrees may couple the inner casing or the outer casing to the coupler ring or the end cap. The shroud may include a partial braze joint that extends less than 360 degrees and couples the coupler ring or the end cap to the inner casing or the outer casing. The partial braze joint may connect to ends of the partial weld joint.

In various aspects, a method of manufacturing a shroud for a suppressor for a firearm is provided. The method may include forming an unfinished shroud comprising an end cap, a coupler ring, an outer casing, and an inner casing. The end cap, the coupler ring, the outer casing, and the inner casing of the unfinished shroud may be fixed relative to each other. The method may include applying a filler metal onto the unfinished shroud, placing the unfinished shroud into a vacuum chamber, decreasing a pressure of an environment within the vacuum chamber to less than a threshold, and while the unfinished shroud is positioned within the vacuum chamber and while the environment is less than the threshold, brazing the unfinished shroud. Brazing the unfinished shroud may form a sealed environment between the inner casing and the outer casing.

In various examples, the forming the unfinished shroud includes welding the coupler ring or the end cap to the inner casing and the outer casing and welding the other of the coupler ring or the end cap to the inner casing or the outer casing. The brazing the unfinished shroud may include brazing the other of the coupler ring or the end cap with the filler metal to the other of the inner casing or the outer casing.

In various examples, the forming the unfinished shroud includes welding the coupler ring or the end cap to the inner casing, the outer casing, or both to form at least one annular weld joint that extends 360 degrees and welding the coupler ring or the end cap to the inner casing or the outer casing to form a partial weld joint that extends less than 360 degrees. The brazing the unfinished shroud may include brazing the coupler ring or the end cap to the inner casing or the outer casing to form a braze joint that connects ends of the partial weld joint.

In various examples, the partial weld joint extends at least 320 degrees.

In various examples, forming the unfinished shroud includes additively manufacturing at least one of the end cap, the coupler ring, the outer casing, or the inner casing.

In various aspects, a suppressor for a firearm is provided. The suppressor defines a forward direction, an aft direction, and a linear projectile path. The suppressor may include a shroud that includes an inner casing and an outer casing that circumferentially surrounds at least a portion of the inner casing. The suppressor may include a coupler ring, an end cap, and a brazed area on at least one of the inner casing, the outer casing, the coupler ring, or the end cap. The end cap, the coupler ring, the outer casing, and the inner casing of the unfinished shroud are fixed relative to each other.

In various examples, the coupler ring further comprises an aft portion that is positioned aft of and longitudinally aligned with the inner casing or the outer casing.

In various examples, the coupler ring is configured to seal an environment within a chamber defined between the inner casing and the outer casing.

In various examples, the shroud further comprises a weld joint that extends 360 degrees that couples the inner casing or the outer casing to the coupler ring or the end cap.

In various examples, the suppressor further comprises an inner body comprising a flange. The flange may define an annular groove. The inner casing may be positioned within the annular groove of the flange. An aft portion of the coupler ring may be positioned between and longitudinally aligned with the flange and the outer casing.

In various examples, a tortuous path is defined between the shroud and the flange.

In various examples, the tortuous path is configured to allow hot gas to be expelled from within the suppressor to an ambient environment outside of the suppressor.

In various examples, the coupler ring comprises a mid portion that is monolithic with a forward portion and an aft portion, and wherein the forward portion and the aft portion of the coupler ring are cylinder shaped.

In various examples, the suppressor further comprises an inner body comprising a flange. The inner casing and the coupler ring may define an annular channel and a rim of the flange may be positioned within the annular channel.

In various examples, a thickness of the annular channel is greater than a thickness of the rim of the flange.

In various examples, the end cap is welded to the inner casing, the outer casing, or both with at least one weld joint that extends 360 degrees.

In various examples, the end cap comprises an annular groove, and wherein the inner casing is positioned within the annular groove of the end cap.

In various examples, at least one of the inner casing, the outer casing, the coupler ring, or the end cap are additively manufactured either separately to form separate components or together to form a monolithic component.

In various examples, a firearm assembly includes the suppressor of claim 6.

In various aspects, a shroud for a suppressor for a firearm is provided. The shroud may include an inner casing and an outer casing. The outer casing may circumferentially surround at least a portion of the inner casing. The shroud may include a coupler ring, an end cap, and a brazed area on the inner casing, the outer casing, the coupler ring, or the end cap.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIG. 1 provides an isometric view of a suppressor, in accordance with an example embodiment.

FIG. 2 provides a side view of the suppressor of FIG. 1, in accordance with an example embodiment.

FIG. 3 provides a cross-sectional view of the suppressor of FIG. 1, in accordance with an example embodiment.

FIG. 4 provides a cross-sectional view of a portion of the suppressor of FIG. 1, in accordance with an example embodiment.

FIG. 5 provides a cross-sectional view of a portion of the suppressor of FIG. 1, in accordance with an example embodiment.

FIG. 6 provides a cross-sectional view of an unfinished shroud, in accordance with an example embodiment.

FIG. 7 provides a cross-sectional view of a portion of a suppressor, in accordance with an example embodiment.

FIG. 8 provides a cross-sectional view of a portion of a suppressor, in accordance with an example embodiment.

FIG. 9 provides a cross-sectional view of an unfinished shroud within a vacuum chamber, in accordance with an example embodiment.

FIG. 10 provides a flowchart of a method of manufacturing a suppressor, in accordance with an example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the term “positioned directly on” refers to a first component being positioned on a second component such that they make contact. Similarly, as used herein, the term “positioned directly between” refers to a first component being positioned between a second component and a third component such that the first component makes contact with both the second component and the third component. In contrast, a first component that is “positioned between” a second component and a third component may or may not have contact with the second component and the third component. Additionally, a first component that is “positioned between” a second component and a third component is positioned such that there may be other intervening components between the second component and the third component other than the first component.

As used herein, terms of approximation, such as “approximately,” “substantially,” or “about,” refer to being within manufacturing or engineering tolerances. For example, terms of approximation may refer to being within a five percent margin of error.

Embodiments of the present disclosure relate generally to a firearm suppressor. The firearm suppressor may be coupled to, or monolithic with a firearm. The firearm may be configured as a rifle or a pistol and may be used with a plurality of different ammunition calibers. For example, various embodiments of the firearm discussed herein may include any firearm capable of utilizing a suppressor, including but not limited to pistols, semi-automatic rifles, bolt-action rifles, or automatic rifles. For example, some embodiments of the firearm may be an AR-15 platform rifle, AR-10 platform rifle, or other similar rifle.

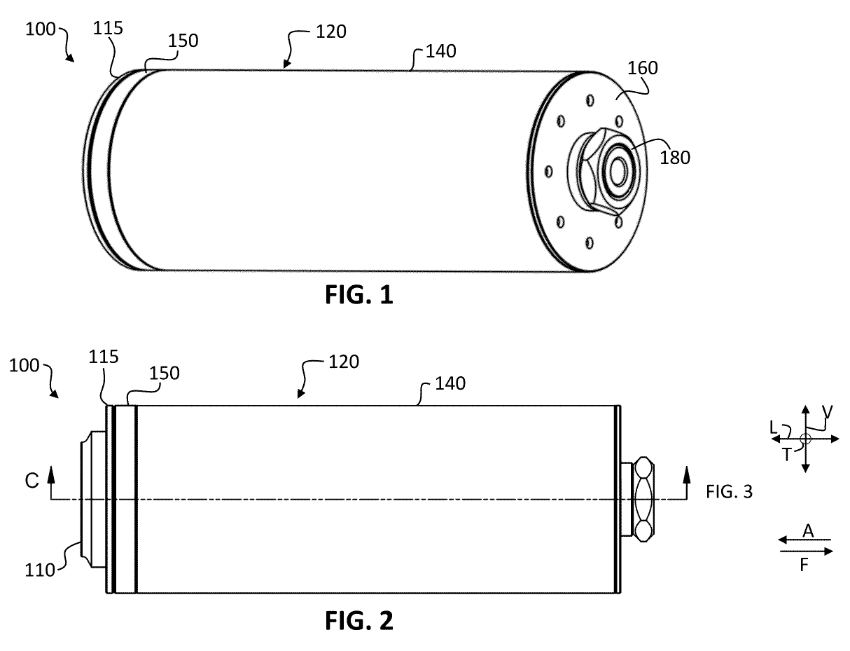

Referring now to FIGS. 1-3, an isometric view, a side view, and a cross-sectional view of a suppressor 100 are provided, in accordance with an example embodiment. The suppressor 100 may define a forward direction, an aft direction, and a linear projectile path P. The suppressor 100 may define a longitudinal direction L that is parallel to the linear projectile path P, a vertical direction V that is orthogonal to the longitudinal direction L, and a transverse direction T that is orthogonal to the longitudinal direction L and the vertical direction V. The suppressor 100 may be configured to couple to a firearm 10. For example, the suppressor 100 may be configured to couple directly to a barrel 12 of a firearm 10 or indirectly to a barrel 12 of a firearm 10 through a muzzle device 14. When the firearm 10 is discharged, a projectile, such as a bullet, may travel along the linear projectile path P and through the suppressor 100.

In various examples, the suppressor 100 includes an inner body 110 and a shroud 120 that circumferentially surrounds at least a portion of the inner body 110. For example, the shroud 120 may circumferentially surround at least eighty percent, such as at least ninety percent of a longitudinal length of the inner body 110. The inner body 110 may include a plurality of baffles 112. The baffles 112 may each define a baffle opening that is positioned on the linear projectile path. The suppressor 100 may include a nut 180 that is coupled to a forward end of the inner body 110 of the suppressor 100. The shroud 120 may be positioned between the inner body 110 and the nut 180 such that the nut 180 retains the position of the shroud 120 relative to the inner body 110. In some embodiments, the shroud 120 may be threaded onto the inner body 110 with or without the nut 180. The inner body 110 and/or the nut 180 may be manufactured from a metal, such as aluminum, stainless steel, or titanium, such as from a titanium alloy that includes at least 80 percent titanium, such as Ti-6Al-4V or Ti-3.5Al-2V.

In various examples, the shroud 120 includes an inner casing 130 and an outer casing 140. The outer casing 140 may circumferentially surround at least a portion of the inner casing 130. For example, the outer casing 140 may circumferentially surround at least eighty percent, such as at least ninety percent of a longitudinal length of the inner casing 130. The inner casing 130 and the outer casing 140 may each be cylindrical shaped. The inner casing 130 and the outer casing 140 may each have a constant wall thickness that deviates by 0.02 inch or less, which may allow the inner casing 130 and the outer casing 140 to be made from an extrusion or a forging, such as an extruded pipe or a forged pipe, which may be easier to procure and more efficient, more accurate, and/or faster than other manufacturing methods, such as manufacturing the inner casing 130 or outer casing 140 from sheet metal. The inner casing 130 and the outer casing 140 may be manufactured from a metal, such as aluminum, stainless steel, or titanium, such as from a titanium alloy that includes at least 80 percent titanium, such as Ti-6Al-4V or Ti-3.5Al-2V.

In various examples, the shroud 120 includes a coupler ring 150. The coupler ring 150 may be joined with or monolithic with the inner casing 130 and the outer casing 140. As used herein, the term “monolithic” refers to a first component being formed as a single piece with a second component. For example, a first component that is monolithic with a second component can be formed as a single piece with an additive manufacturing process (e.g., 3D printing) or a subtractive manufacturing process (e.g., machining from a solid piece of material). The additive manufacturing process may be a direct energy deposition process (e.g., powder direct energy deposition or wire direct energy deposition), a powder bed fusion process (e.g., selective laser melting or electron beam melting), a binder jetting process, or a bound powder extrusion process. As used herein, the term “joined to” refers to a first component being formed separately than a second component and subsequently being connected to the second component via a joining process, such as a welding process or a brazing process. In various embodiments, one or more components described herein may be additively manufactured separately or may be additively manufactured as a monolithic component (e.g., a monolithic subassembly comprising two or more components described herein).

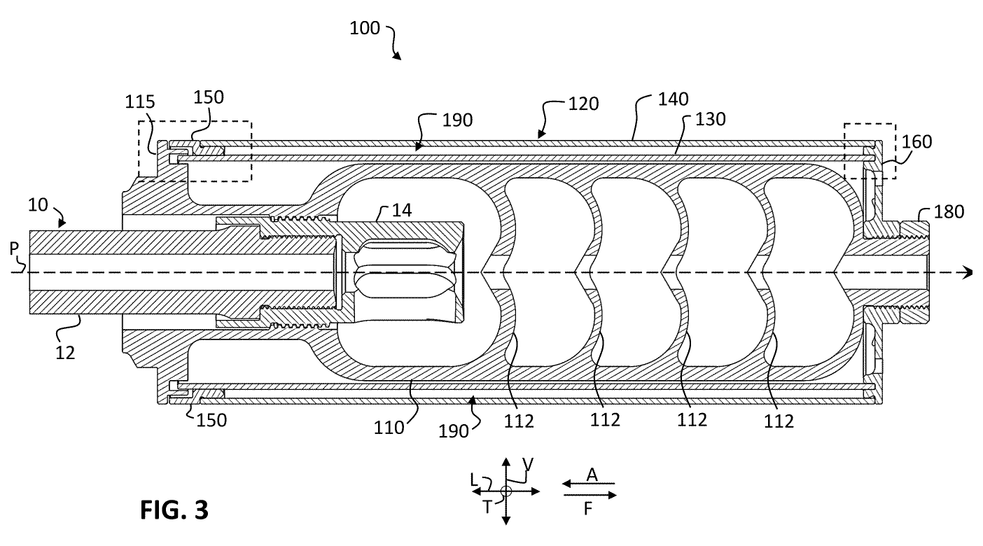

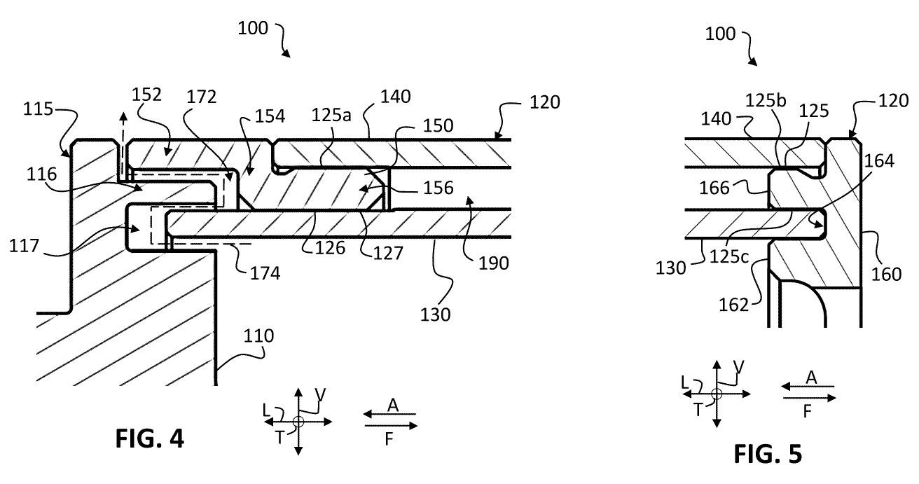

The coupler ring 150 may have a cross-sectional Z-shape as shown in the depicted embodiment. At least a portion of the coupler ring 150, such as a forward portion 156 (FIG. 4), may be positioned radially between the outer casing 140 and the inner casing 130. For example, at least thirty percent, such as at least forty percent of a longitudinal length of the coupler ring 150 may be positioned radially between the outer casing 140 and the inner casing 130. At least another portion, such as an aft portion 152 (FIG. 4) of the coupler ring 150 may be positioned longitudinally between the outer casing 140 and the inner body 110, as depicted in FIG. 3. In various examples, the aft portion 152 of the coupler ring 150 may have a larger diameter than the forward portion 156 of the coupler ring 150. The coupler ring 150 may be manufactured from a metal, such as aluminum, stainless steel, or titanium, such as from a titanium alloy that includes at least 80 percent titanium, such as Ti-6Al-4V or Ti-3.5Al-2V.

Referring to FIG. 4, a view of a portion of the suppressor 100 of FIGS. 1-3 is depicted, in accordance with an example embodiment. As discussed, the coupler ring 150 may include a forward portion 156 that is positioned radially between the inner casing 130 and the outer casing 140. The coupler ring 150 may include an aft portion 152 that is positioned aft of and longitudinally aligned with the inner casing 130 or the outer casing 140. As used herein, the term “longitudinally aligned” refers to two components being positioned at least partially on an imaginary line that extends parallel to the longitudinal direction L. The coupler ring 150 may include a mid portion 154 that is monolithic with the forward portion 156 and the aft portion 152. Each of the forward portion 156 and the aft portion 152 of the coupler ring 150 may be cylinder shaped.

In various examples, the outermost outer diameter of the coupler ring 150 is approximately equal to (e.g., within 0.01 inch) an outermost outer diameter of the outer casing 140. As such, the aft portion 152 may be positioned such that an outer surface of the aft portion 152 of the coupler ring 150 is flush with an outer surface of the outer casing 140. Further, an outermost outer diameter of the inner body 110 may be approximately equal to (e.g., within 0.01 inch) an outermost outer diameter of the coupler ring 150. As such, the inner body 110 may be positioned such that an outer surface of the inner body 110 is flush with the outer surface of the aft portion 152 of the coupler ring 150.

In various examples the inner body 110 of the suppressor 100 comprises a flange 115. The flange 115 may be on an aft portion 152 of the inner body 110 and may generally extend radially outward. An outermost outer diameter of the flange 115 may be approximately equal to (e.g., within 0.1 inch) the outermost outer diameter of the coupler ring 150 and/or the outer casing 140. The flange 115 may include a rim 116 that extends circumferentially and forward (e.g., towards the coupler ring 150). The rim 116 may define an annular groove 117 that extends circumferentially and is positioned radially inward from the rim 116. The rim 116 may be inset from an outermost edge of the flange 115.

In various examples, the inner casing 130 is positioned at least partially within the annular groove 117 of the flange 115 of the inner body 110. A ratio between a thickness of the portion of the inner casing 130 that is within the annular groove 117 and a radial height of the annular groove 117 may be at least 5:10 and up to 9:5:10. The thickness of the portion of the inner casing 130 that is within the annular groove 117 may be less than a radial height of the annular groove 117 by less than 0.08 inch, such as less than 0.07 inch, such as less than 0.06 inch, such as less than 0.05 inch, such as at least 0.01 inch and up to 0.05 inch, such as at least 0.02 inch and up to 0.05 inch. An outermost outer diameter of the portion of the inner casing 130 that is within the annular groove 117 may be less than an innermost inner diameter of the rim 116. As such, the inner casing 130 may be positioned such that the inner casing 130 does not make contact with the inner body 110. In various examples, the flange 115 does not include an annular groove 117 and the inner casing 130 is positioned proximate to, but not making contact with, the flange 115.

In various examples, the forward portion 156 of the coupler ring 150 is longitudinally aligned with the rim 116 of the flange 115 of the inner body 110. An annular channel 172 may be defined between the forward portion 156 of the coupler ring 150 and the rim 116. The annular channel 172 may have a longitudinal width that is less than 0.08 inch, such as less than 0.07 inch, such as less than 0.06 inch, such as less than 0.05 inch, such as at least 0.01 inch and up to 0.05 inch, such as at least 0.02 inch and up to 0.05 inch. As such, the mid portion 154 and/or the forward portion 156 of the coupler ring 150 may be positioned such that the rim 116 of the flange 115 of the inner body 110 does not make contact with the mid portion 154 and/or the forward portion 156.

In various examples, the innermost inner diameter of the aft portion 152 of the coupler ring 150 is greater than an outermost outer diameter of the rim 116 by less than 0.08 inch, such as less than 0.07 inch, such as less than 0.06 inch, such as less than 0.05 inch, such as at least 0.01 inch and up to 0.05 inch, such as at least 0.02 inch and up to 0.05 inch. As such, the coupler ring 150 may be positioned such that the coupler ring 150 does not make contact with the rim 116.

In various examples, neither the inner casing 130 nor the coupler ring 150 of the shroud 120 make contact with the inner body 110. As such, a tortuous path 174 may be defined between the shroud 120 and the inner body 110 near an aft end of the suppressor 100. The tortuous path 174 may include a plurality of radially extending portions and a plurality of circumferentially extending portions. The tortuous path 174 may have a cross-sectional serpentine shape. The tortuous path 174 may be configured to allow hot gas to be expelled from within the inner body 110 to an ambient environment outside of the suppressor 100 when the firearm 10 to which the suppressor 100 is coupled is discharged. Referring back to FIG. 3, the shroud 120 may be coupled to the inner body 110 via threads on the end cap 160 that mate with threads on the inner body 110. As such, the axial clearances between the shroud 120 and the inner body 110 may be maintained to define the tortuous path 174.

Referring to FIG. 5, a view of another portion of the suppressor 100 of FIGS. 1-3 is depicted, in accordance with an example embodiment. As discussed, the shroud 120 may include an end cap 160. The end cap 160 may include an inner lip 162 that extends circumferentially and aft. The inner lip 162 may be positioned radially inward from the inner casing 130. The end cap 160 may include an outer lip 166 that extends circumferentially and aft. The outer lip 166 may be positioned radially between the outer casing 140 and the inner casing 130. The inner casing 130 may be positioned radially between the inner lip 162 and the outer lip 166. For example, the inner lip 162 and the outer lip 166 may define an annular slot 164. The inner casing 130 may be positioned within the annular slot 164.

Referring back to FIG. 3, a chamber 190 may be defined between the inner casing 130 and the outer casing 140. As will be discussed further, the coupler ring 150 and/or the end cap 160 may be joined to the inner casing 130 and the outer casing 140 to seal, such as hermetically seal, an environment, such as a low-pressure environment, within the chamber 190 of the shroud 120. As used herein, the term “low-pressure environment” may refer to a pressure that is below the ambient pressure surrounding the shroud 120, a pressure needed to achieve desired thermal transfer reduction or noise attenuation by the shroud 120, and/or a pressure that is less than 100 millibar (mBar).

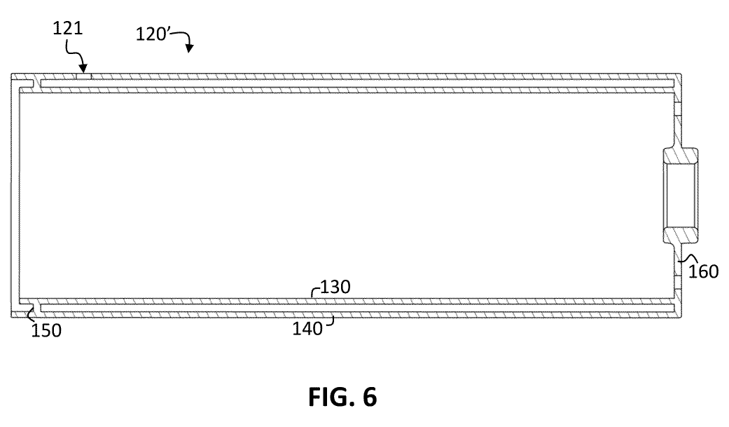

Referring now to FIG. 6, a cross-sectional view of an unfinished shroud 120’ is depicted, in accordance with an example embodiment. In various examples, at least some of the components of the unfinished shroud 120’ may be monolithic with other components of the unfinished shroud 120’. For example, the inner casing 130 or the outer casing 140 can be monolithic with the end cap 160 and/or the coupler ring 150. As depicted in the example embodiment of FIG. 6, both the inner casing 130 and the outer casing 140 may be monolithic with the end cap 160 and the coupler ring 150. In various examples, the unfinished shroud 120’ is additively manufactured (e.g., 3D printed) to form each of the components such that they are monolithic with each other.

The coupler ring 150 may have an annular shape, as shown in the depicted embodiment. The coupler ring 150 may be manufactured from a metal, such as aluminum, stainless steel, or titanium, such as from a titanium alloy that includes at least 80 percent titanium, such as Ti-6Al-4V or Ti-3.5Al-2V.

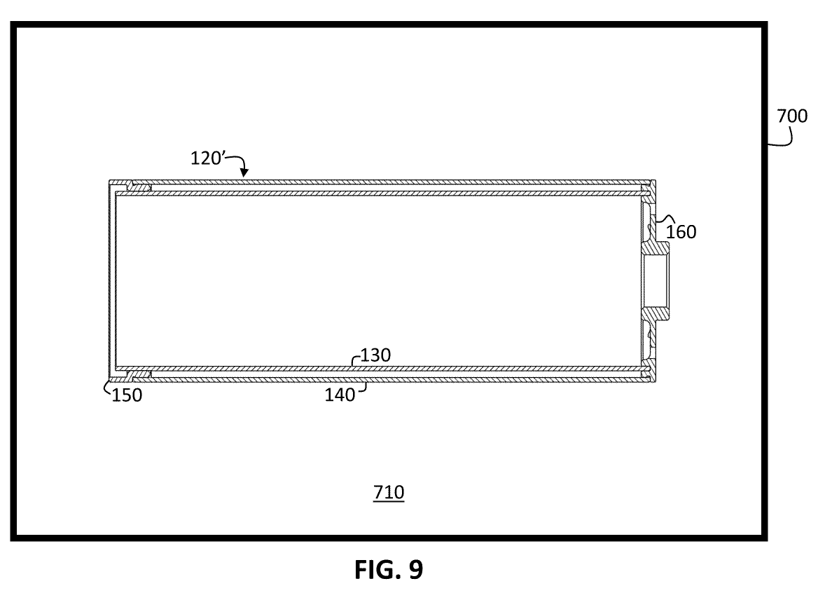

In various examples, a chamber 190 may be defined between the inner casing 130 and the outer casing 140 of the unfinished shroud 120’. The unfinished shroud 120’ can include an opening 121 that fluidically connects the chamber 190 with an environment exterior to the unfinished shroud 120’. For example, the opening 121 allows gas to travel from a position within the chamber 190 to a position exterior to the chamber 190. As will be discussed further, the opening 121 may be closed to seal, such as hermetically seal, an environment, such as a low-pressure environment, within the chamber 190 of the shroud 120. The opening 121 may be closed with a brazing process while the unfinished shroud 120’ is positioned in a low-pressure environment 710 within a vacuum chamber 700 (FIG. 9). Various other embodiments discussed herein may additionally or alternatively include an opening that may be brazed shut as described herein. In such embodiments, the opening may be the only portion of the suppressor shroud that is brazed (e.g., the remaining shroud being additively manufactured and/or welded) or one or more other areas of the suppressor may be brazed (with or without additive manufacturing and/or welding of any components or subassemblies).

The opening 121 may be positioned anywhere on the unfinished shroud 120 that connects the exterior environment to the chamber between the inner casing 130 and the outer casing 140. For example, and as depicted, the opening 121 may be positioned on the outer casing 140 of the unfinished shroud 120’. The opening 121 may be positioned on the inner casing 130, the coupler ring 150, or the end cap 160.

When one or more components of the shroud 120 are formed using an additive manufacturing process, the opening 121 may be formed during the additive manufacturing process. In various examples, the opening 121 is formed after the one or more components are formed. For example, the opening 121 may be subtractively manufactured (e.g., machined or laser drilled) into the one or more components.

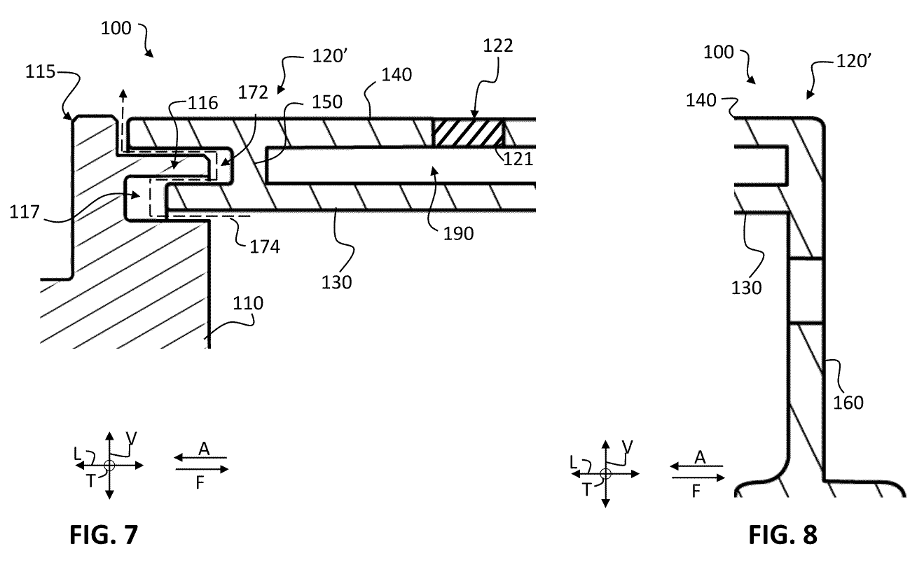

Referring to FIG. 7, a view of a portion of a suppressor 100 that includes the shroud 120 of FIG. 6 in a finished state is depicted, in accordance with an example embodiment. The shroud 120 can include an inner casing 130, an outer casing 140, and a coupler ring 150. The coupler ring 150 may be positioned radially between the outer casing 140 and the inner casing 130. For example, an entirety of the coupler ring 150 may be positioned radially between the outer casing 140 and the inner casing 130.

As discussed, the inner body 110 of the suppressor 100 may comprise a flange 115. An outermost outer diameter of the flange 115 may be approximately equal to (e.g., within 0.1 inch) the outermost outer diameter of the outer casing 140.

In various examples, the inner casing 130 is positioned at least partially within an annular groove 117 of the flange 115 of the inner body 110. A ratio between a thickness of the portion of the inner casing 130 that is within the annular groove 117 and a radial height of the annular groove 117 may be at least 5:10 and up to 9:5:10. The thickness of the portion of the inner casing 130 that is within the annular groove 117 may be less than a radial height of the annular groove 117 by less than 0.08 inch, such as less than 0.07 inch, such as less than 0.06 inch, such as less than 0.05 inch, such as at least 0.01 inch and up to 0.05 inch, such as at least 0.02 inch and up to 0.05 inch.

The flange 115 may include a rim 116 that extends circumferentially and forward (e.g., towards the coupler ring 150). The rim 116 may define the annular groove 117 that extends circumferentially and is positioned radially inward from the rim 116. The rim 116 may be inset from an outermost edge of the flange 115. An outermost outer diameter of the portion of the inner casing 130 that is within the annular groove 117 may be less than an innermost inner diameter of the rim 116. As such, the inner casing 130 may be positioned such that the inner casing 130 does not make contact with the inner body 110. In various examples, the flange 115 does not include an annular groove 117 and the inner casing 130 is positioned proximate to, but not making contact with, the flange 115.

In various examples, the coupler ring 150 is longitudinally aligned with the rim 116 of the flange 115 of the inner body 110. An annular channel 172 may be defined between the coupler ring 150 and the rim 116. The annular channel 172 may have a longitudinal width that is less than 0.08 inch, such as less than 0.07 inch, such as less than 0.06 inch, such as less than 0.05 inch, such as at least 0.01 inch and up to 0.05 inch, such as at least 0.02 inch and up to 0.05 inch. As such, the coupler ring 150 may be positioned such that the rim 116 of the flange 115 of the inner body 110 does not make contact with the coupler ring 150.

In various examples, the innermost inner diameter of the outer casing 140 is greater than an outermost outer diameter of the rim 116 by less than 0.08 inch, such as less than 0.07 inch, such as less than 0.06 inch, such as less than 0.05 inch, such as at least 0.01 inch and up to 0.05 inch, such as at least 0.02 inch and up to 0.05 inch. As such, the outer casing 140 may be positioned such that the outer casing 140 does not make contact with the rim 116.

In various examples, neither the inner casing 130 nor the coupler ring 150 of the shroud 120 make contact with the inner body 110. As such, a tortuous path 174 may be defined between the shroud 120 and the inner body 110 near an aft end of the suppressor 100. The tortuous path 174 may include a plurality of radially extending portions and a plurality of circumferentially extending portions. The tortuous path 174 may have a cross-sectional serpentine shape. The tortuous path 174 may be configured to allow hot gas to be expelled from within the inner body 110 to an ambient environment outside of the suppressor 100 when the firearm 10 to which the suppressor 100 is coupled is discharged. Additionally, the tortuous path 174 may allow the suppressor 100, such as the inner body 110 of the suppressor, to expand when heated in a uniform matter to prevent axial misalignment of the suppressor 100 with the barrel 12. The shroud 120 may be coupled to the inner body 110 via threads on the end cap 160 that mate with threads on the inner body 110. As such, the axial clearances between the shroud 120 and the inner body 110 may be maintained to define the tortuous path 174.

Referring to FIG. 8, a view of another portion of the suppressor of FIG. 7 is depicted, in accordance with an example embodiment. As discussed, the shroud 120 may include an end cap 160. The end cap 160 may be monolithic with a forward end of the inner casing 130. The end cap 160 may be monolithic with a forward end of the outer casing 140.

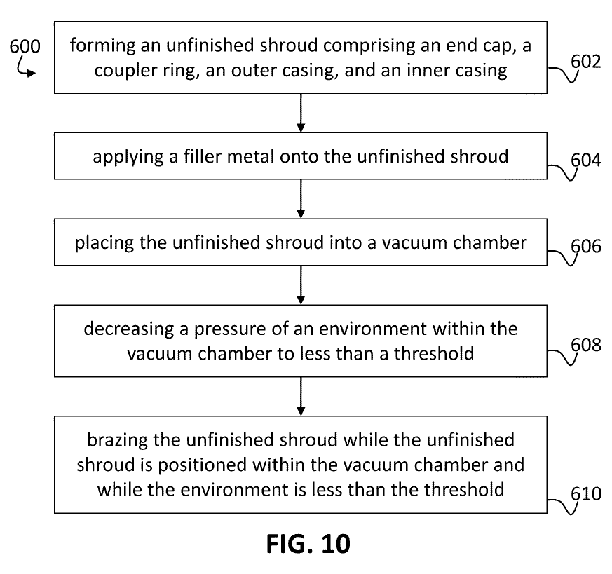

Referring now to FIG. 10, a flowchart for a method 600 of manufacturing a shroud 120 for a suppressor 100 for a firearm 10 is depicted, in accordance with an example embodiment. In some embodiments, the method 600 may include a step 602 of forming an unfinished shroud 120’ comprising an end cap 160, a coupler ring 150, an outer casing 140, and an inner casing 130. The step 62 of forming the unfinished shroud 120’may include welding a portion of the unfinished shroud 120’ together prior to inserting the unfinished shroud 120’ into a vacuum chamber 700 and brazing the remaining portion of the unfinished shroud 120’ together, thereby forming a sealed, low-pressure chamber between the inner casing 130 and outer casing 140, which forms a shroud 120 that is finished. The step 602 of forming the unfinished shroud 120’may include welding at least a portion of a coupler ring 150 or at least a portion of an end cap 160 to an inner casing 130, an outer casing 140, or both to form an unfinished shroud 120’. For example, step 602 may include welding the coupler ring 150 or the end cap 160 to the inner casing 130 and the outer casing 140 and welding the other of the coupler ring 150 or the end cap 160 to the inner casing 130 or the outer casing 140. Step 602 may include welding the coupler ring 150 and the end cap 160 to the inner casing 130 and the outer casing 140.

As used herein, the term “welding” refers to a fabrication process that joins components comprising metals, such as aluminum, stainless steel, or titanium alloys, by using a high temperature that is sufficient to melt the one or more metals that the component is manufactured from and allowing them to cool, which may cause fusion of the two components. In other words, the temperature used during the welding process exceeds a melting point of the one or more metals that the components comprise. For example, if the components of the unfinished shroud 120’ are all made from titanium alloy Ti-6Al-4V, which has a melting point of 2,920 degrees Fahrenheit, the welding process may apply a heat onto the components that is greater than 2,920 Fahrenheit to melt the respective components and join them together. Additionally, phrases similar to “welding a first component to a second component” should be understood as being non-directional and that the phrase includes the second component being welded to the first component.

The step 602 of forming the unfinished shroud 120’, the unfinished shroud 120’ comprising an end cap 160, a coupler ring 150, an outer casing 140, and an inner casing 130, may include additively manufacturing at least one of the end cap 160, the coupler ring 150, the outer casing 140, and the inner casing 130. For example, each of the end cap 160, the coupler ring 150, the outer casing 140, and the inner casing 130 can be additively manufactured separately to form separate components. Two, Three, or each of the end cap 160, the coupler ring 150, the outer casing 140, and the inner casing 130 can be additively manufactured together to form a monolithic component. In an instance in which two or three of the end cap 160, the coupler ring 150, the outer casing 140, and the inner casing 130 are additively manufactured together to form a monolithic component, the other of the end cap 160, the coupler ring 150, the outer casing 140, and the inner casing 130 can be separately additively manufactured or subtractively manufactured. The components that are monolithically formed can be joined with the one or more components that are separately formed with a brazing process or a welding process. In an instance in which each of the end cap 160, the coupler ring 150, the outer casing 140, and the inner casing 130 are separately formed by additively or subtractively manufacturing, each component can be subsequently joined via a welding process or a brazing process.

The method 600 may include a step 604 of applying a filler metal onto the unfinished shroud 120’. For example, the filler metal may be applied to at least one of the coupler ring 150, the end cap 160, the inner casing 130, and/or the outer casing 140. In various examples, the step 604 of applying the filler metal onto the unfinished shroud 120’ may include applying the filler metal onto the opening 121 that is formed on the unfinished shroud 120’.

The filler metal may be placed onto the unfinished shroud 120’ after the step 602 of forming the unfinished shroud 120’. The filler metal may have a lower melting point than the component that the filler metal is applied. For example, if the filler metal is applied to the inner casing 130 and/or the coupler ring 150 and both are made from a titanium alloy Ti-6Al-4V, which has a melting point of 2,920 degrees Fahrenheit, the filler metal may have a melting point that is less than 2,920 degrees Fahrenheit, such as less than 2,000 degrees Fahrenheit, such as at least 1,5000 degrees Fahrenheit and up to 1,700 degrees Fahrenheit. For example, the filler metal may be a titanium brazing alloy, such as Ti-37.5Zr-10Ni-15Cu, which has a melting point of approximately 1,571 degrees Fahrenheit or Ti-15Cu-15Ni, which has a melting point of approximately 1,715 degrees Fahrenheit, to name a few examples.

The method 600 may include a step 606 of placing the unfinished shroud 120’ into a vacuum chamber 700, which may create a low pressure environment that is below a threshold pressure, which may include a vacuum or a near vacuum. The threshold pressure may be a pressure that is equal to or less than a maximum pressure that eliminates the need for use of fluxes within the filler material during the vacuum brazing process. Not including fluxes within the filler material may result in stronger brazed areas, such as brazed joints or brazed points, than can be achieved using filler material that includes fluxes. The threshold pressure may be a pressure that is equal to or less than a pressure within the chamber 190 needed to achieve a desired amount of heat transmission reduction or amount of noise attenuation by the suppressor 100. The threshold pressure may be less than 100 millibar (mBar), such as less than 50 mBar, such as less than 25 mBar, such as less than 15 mBar. For example, the threshold pressure may be at least 5 mBar and up to 25 mBar, such as at least 5 mBar and up to 15 mBar.

In various examples, the unfinished shroud 120’ with the filler metal applied to it may be placed into a vacuum chamber 700 or the unfinished shroud 120’ may be placed into the vacuum chamber 700 and the filler metal may be applied to the unfinished shroud 120’ while the unfinished shroud 120’ is within the vacuum chamber 700. The method 600 may include a step 608 of decreasing a pressure of an environment 710 within the vacuum chamber 700 to less than the threshold while the unfinished shroud 120’ with the filler metal is positioned within the vacuum chamber 700.

The method 600 may include a step 610 of brazing the unfinished shroud 120’ while the unfinished shroud 120’ is positioned within the vacuum chamber 700 and while the environment 710 is less than a threshold, such as less than 100 mBar. In various examples, brazing the unfinished shroud 120’ comprises brazing the coupler ring 150 or the end cap 160 with the filler metal to the outer casing 140, the inner casing 130, or both, while the unfinished shroud 120’ is positioned within the vacuum chamber 700 and while the environment 710 is less than a threshold, such as less than 100 mBar to form a brazed area, such as a brazed joint. In various examples, brazing the unfinished shroud 120’ comprising brazing the opening 121 of the unfinished shroud 120’ to seal the opening 121 while the unfinished shroud 120’ is positioned within the vacuum chamber 700 and while the environment 710 is less than a threshold, such as less than 100 mBar to form a brazed area, such as a brazed point 122 (FIG. 7).

In various examples, a temperature within the vacuum chamber 700 may be increased to a temperature that exceeds the melting point of the filler metal but is less than the melting point of the material that the components of the unfinished shroud 120’ are manufactured from to braze the unfinished shroud 120. For example, if the components of the unfinished shroud 120’ are all manufactured from Ti-6Al-4V, which has a melting point of 2,920 degrees Fahrenheit, and the filler metal is Ti-37.5Zr-10Ni-15Cu, which has a melting point of approximately 1,571 degrees Fahrenheit, the temperature within the vacuum chamber 700 can be increased to at least 1,571 and up to 2,920 degrees Fahrenheit to melt the filler metal while not melting the unfinished shroud 120.

As compared to the term “welding”, the term “brazing”, as used herein, refers to a fabrication process that joins components comprising metals, such as aluminum, stainless steel, or titanium alloys, by using high temperature (but not as high as welding) to melt filler metals but not the metals that the component is manufactured from and allowing them to cool, which may cause fusion of the two components. For example, to braze the coupler ring 150 to the outer casing 140, a brazing material may be added and melted therebetween without melting either of the outer casing 140 or the coupler ring 150. Additionally, phrases similar to “brazing a first component to a second component” should be understood as being non-directional and that the phrase includes the second component being brazed to the first component.

In various examples, brazing the unfinished shroud 120’ forms a sealed, such as hermetically-sealed, low-pressure environment between the inner casing 130 and the outer casing 140. For example, the chamber 190 (FIG. 3) that is between the outer casing 140 and the inner casing 130 may have a low-pressure environment that is less than a threshold, such as less than 100 mBar.

In various examples, a majority of the adjacent surfaces of the inner casing 130, outer casing 140, coupler ring 150, and end cap 160 may be welded together to form the unfinished shroud 120. For example, forming the unfinished shroud 120’ may include welding the coupler ring 150 or the end cap 160 to the inner casing 130, the outer casing 140, or both to form at least one annular weld area, such as at least one weld joint 125 that extends 360 degrees around the linear projectile path P. For example, the at least one annular weld joint 125 may extend circumferentially 360 degrees or may have at least some portions that extend at least partially forward or aft (e.g., the annular weld joint 125 may have some portions that have a zig-zag or serpentine shape that extends around the linear projectile path P). As used herein, a joint that “extends 360 degrees” refers to the coverage of the joint rather than the distance traveled by the welding joint. For example, the term “extends 360 degrees” includes a weld joint 125 that over-welds and is applied in more than 360 degrees. Also, a joint that “extends 360 degrees” is inclusive of a plurality of joints that connect and extend 360 degrees or more. In various examples, two or three annular weld joints 125 that each extend 360 degrees are formed by welding the coupler ring 150 or the end cap 160 to both the inner casing 130 and the outer casing 140. In various examples, two or three annular weld joints that each extend 360 degrees are formed by welding the coupler ring 150 and the end cap 160 to the inner casing 130 or the outer casing 140. In various examples, joint at the same end of the shroud 120 (e.g., the joints formed between the inner casing 130 and the end cap 160 and the outer casing 140 and the end cap 160) may overlap to form a contiguous weld joint.

In various examples, three annular weld joints that each extend 360 degrees are formed by welding the coupler ring 150 and the end cap 160 to the inner casing 130 or the outer casing 140 and by welding the coupler ring 150 or the end cap 160 to the other of the inner casing 130 or the outer casing 140. In various examples, three annular weld joints that each extend 360 degrees are formed by welding the coupler ring 150 or the end cap 160 to the inner casing 130 and the outer casing 140 and by welding the other of the coupler ring 150 or the end cap 160 to the inner casing 130 or the outer casing 140. For example, weld joint 125a may be formed between the coupler ring 150 and the outer casing 140, weld joint 125b may be formed between the outer casing 140 and the end cap 160, and weld joint 125c may be formed between the end cap 160 and the inner casing 130. However, other combination of locations for the weld joints 125 are contemplated.

In various examples, the step 602 of forming the unfinished shroud 120’ includes welding the coupler ring 150, the end cap 160, or both to the inner casing 130, the outer casing 140, or both to form at least one partial weld joint that extends less than 360 degrees, such as less than 359 degrees, such as less than 355 degrees, such as less than 350 degrees, such as less than 340 degrees. For example, each partial weld joint may extend at least 180 degrees and less than 360 degrees, such as at least 300 degrees and up to 350 degrees, such as at least 310 degrees and up to 340 degrees, such as at least 320 degrees and up to 330 degrees. Each partial weld joint may extend at least 320 degrees but less than 360 degrees, at least 350 degrees but less than 360 degrees, such as at least 355 degrees but less than 360 degrees.

In various examples, the method 600 may include a step of brazing the coupler ring 150 or the end cap 160 to the inner casing 130 or the outer casing 140 to form a partial braze area, such as a partial braze joint 127 that connects ends of the partial weld joint that extends less than 360 degrees. For example, if a partial weld joint extended 325 degrees, the partial braze joint 127 would extend 35 degrees and would connect with the ends of the partial weld joint.

The method 600 of manufacturing that includes a step 602 of forming the unfinished shroud 120’ that includes welding and a step 610 of brazing has various benefits. For example, most welding processes are difficult or impossible to perform in a low-pressure environment (e.g., an environment that is less than 100 mBar). In some instances, a user or machinery may be unable to physically reach the components to weld or otherwise actively attach them while in the vacuum chamber 700, and a passive attachment like brazing may be more effectively and efficiently formed in a vacuum chamber 700. As such, it may be prohibitively difficult to weld all the components of the shroud 120 together in a low-pressure environment 710 to create the low-pressure chamber 190 between the inner casing 130 and the outer casing 140. Similarly, it may be prohibitively difficult, inaccurate, and/or inefficient to apply a low pressure environment to the chamber 190 via less intrusive means, such as hoses or pumps that may allow external exposure to the welded components. In contrast, the brazing processes may be performed in a low-pressure environment 710 and, in some instances, may form a stronger joint and/or may be more efficiently formed within the low-pressure environment 710. In some examples, welding may form a stronger, more reliable, and/or faster joint. As such, it may be beneficial to include both a welding process and a brazing process in the manufacturing of the shroud 120. For example, and as discussed, a majority of the surfaces of the components of the shroud 120 to be joined may be joined with a welding process at an ambient pressure while the remaining surfaces of the components of the shroud 120 to be joined may be joined with a brazing process in a low-pressure environment 710, which may seal, such as hermetically seal, a low-pressure environment within the chamber 190 defined between the inner casing 130 and the outer casing 140.

The method 600 of manufacturing that includes a step 602 of forming the unfinished shroud 120’ that includes additive manufacturing may reduce the amount of welding or eliminate the welding processes and/or the subtractive manufacturing processes. In some embodiments, at least a first portion of the unfinished shroud (e.g., one or more components) may be additively manufactured as separate components or a monolithic subassembly while other portions of the unfinished shroud are manufactured by additive manufacturing and/or subtractive manufacturing and joined with the first portion. Reducing or eliminating the welding process and/or the subtractive manufacturing process may result in a shroud 200 that can be more efficiently produced and/or can have geometries that may not be able to be accomplished with a welding process or a subtractive manufacturing process.

Sealing, such as hermetically sealing, a low-pressure environment within the chamber 190 that may be defined between the inner casing 130 and the outer casing 140 has various benefits. For example, thermal energy (e.g., heat) and sound waves do not travel through low-pressure environments as well as ambient environments. As such, incorporating a chamber 190 that has an environment within that is less than 100 mBar, as compared to an ambient pressure, may reduce an amount of heat transmitted to the outer casing 140 of the shroud 120 of the suppressor 100 and/or increase an amount of noise attenuation by the suppressor 100, which may improve the longevity and performance of the suppressor 100 relative to a standard suppressor.

Referring back to FIGS. 1-6, the shroud 120 manufactured using the manufacturing method 600 of FIG. 10 may include at least one annular weld area, such as at least one annular weld joint 125 that extends 360 degrees. For example, each annular weld joint 125 may join the inner casing 130 or the outer casing 140 to the end cap 160 or the coupler ring 150. In various examples, the shroud 120 may include at least two annular weld joints 125, such as three annular weld joints 125 that each extend 360 degrees. For example, a first weld joint 125a may join the outer casing 140 to the coupler ring 150, a second weld joint 125b may join the outer casing 140 to the end cap 160, and a third weld joint 125c may join the inner casing 130 to the end cap 160. In some embodiments, the fourth joint 126 may be entirely or partially brazed.

In various examples, the shroud 120 may include at least one partial weld area, such as at least one partial weld joint that extends less than 360 degrees. For example, the shroud 120 may include a partial weld joint that joins the coupler ring 150 with the inner casing 130. In various examples, the shroud 120 may include at least one partial braze joint 127. For example, the shroud 120 may include a partial braze joint 127 that joins the coupler ring 150 with the inner casing 130 and connects the partial weld joint that joins the coupler ring 150 with the inner casing 130. It should be understood, however, that the position of the at least one partial weld joint and the at least one partial braze joint 127 may be positioned to join the coupler ring 150 with the outer casing 140, the outer casing 140 with the end cap 160, or the end cap 160 with the inner casing 130.

In various examples, the shroud 120 manufactured using the manufacturing method 600 of FIG. 10 may include at least one braze point 122 (FIG. 7). For example, an opening 121 formed in the unfinished shroud 120’ may be filled with a filler metal and subsequently brazed to form the at least one braze point 122.

### Conclusion

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the appended claims below. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method of manufacturing a shroud for a suppressor for a firearm, the method comprising:
forming an unfinished shroud comprise
ng an end cap, a coupler ring, an outer casing, and an inner casing, wherein the end cap, the coupler ring, the outer casing, and the inner casing of the unfinished shroud are fixed relative to each other;
applying a filler metal onto the unfinished shroud;
placing the unfinished shroud into a vacuum chamber;
decreasing a pressure of an environment within the vacuum chamber to less than a threshold; and
while the unfinished shroud is positioned within the vacuum chamber and while the environment is less than the threshold, brazing the unfinished shroud,
wherein brazing the unfinished shroud forms a sealed environment between the inner casing and the outer casing.

2. The method of claim 1, wherein the forming the unfinished shroud comprises:
welding the coupler ring or the end cap to the inner casing and the outer casing; and
welding the other of the coupler ring or the end cap to the inner casing or the outer casing,
wherein the brazing the unfinished shroud comprises brazing the other of the coupler ring or the end cap with the filler metal to the other of the inner casing or the outer casing.

3. The method of claim 1, wherein the forming the unfinished shroud comprises:
welding the coupler ring or the end cap to the inner casing, the outer casing, or both to form at least one annular weld joint that extends 360 degrees; and
welding the coupler ring or the end cap to the inner casing or the outer casing to form a partial weld joint that extends less than 360 degrees,
wherein the brazing the unfinished shroud comprises brazing the coupler ring or the end cap to the inner casing or the outer casing to form a braze joint that connects ends of the partial weld joint.

4. The method of claim 3, wherein the partial weld joint extends at least 320 degrees.

5. The method of claim 1, wherein forming the unfinished shroud comprises:
additively manufacturing at least one of the end cap, the coupler ring, the outer casing, or the inner casing.

6. A suppressor for a firearm, the suppressor defining a forward direction, an aft direction, and a linear projectile path, the suppressor comprising:
a shroud comprising:
an inner casing;
an outer casing, wherein the outer casing circumferentially surrounds at least a portion of the inner casing;
a coupler ring;
an end cap; and
a brazed area on at least one of the inner casing, the outer casing, the coupler ring, or the end cap, wherein the end cap, the coupler ring, the outer casing, and the inner casing of the shroud are fixed relative to each other.

7. The suppressor of claim 6, wherein the coupler ring further comprises an aft portion that is positioned aft of and longitudinally aligned with the inner casing or the outer casing.

8. The suppressor of claim 6, wherein the coupler ring is configured to seal an environment within a chamber defined between the inner casing and the outer casing.

9. The suppressor of claim 6, wherein the shroud further comprises a weld joint that extends 360 degrees that couples the inner casing or the outer casing to the coupler ring or the end cap.

10. The suppressor of claim 6, wherein the suppressor further comprises an inner body comprising a flange, wherein:
the flange defines an annular groove,
the inner casing is positioned within the annular groove of the flange, and
an aft portion of the coupler ring is positioned between and longitudinally aligned with the flange and the outer casing.

11. The suppressor of claim 10, wherein a tortuous path is defined between the shroud and the flange.

12. The suppressor of claim 11, wherein the tortuous path is configured to allow hot gas to be expelled from within the suppressor to an ambient environment outside of the suppressor.

13. The suppressor of claim 6, wherein the coupler ring comprises a mid portion that is monolithic with a forward portion and an aft portion, and wherein the forward portion and the aft portion of the coupler ring are cylinder shaped.

14. The suppressor of claim 6, wherein:
the suppressor further comprises an inner body comprising a flange,
the inner casing and the coupler ring define an annular channel, and
a rim of the flange is positioned within the annular channel.

15. The suppressor of claim 14, wherein a thickness of the annular channel is greater than a thickness of the rim of the flange.

16. The suppressor of claim 6, wherein the end cap is welded to the inner casing, the outer casing, or both with at least one weld joint that extends 360 degrees.

17. The suppressor of claim 16, wherein the end cap comprises an annular groove, and wherein the inner casing is positioned within the annular groove of the end cap.

18. The suppressor of claim 6, wherein at least one of the inner casing, the outer casing, the coupler ring, or the end cap are additively manufactured either separately to form separate components or together to form a monolithic component.

19. A firearm comprising the suppressor of claim 6.

20. A shroud for a suppressor for a firearm, the shroud comprising:
an inner casing;
an outer casing, wherein the outer casing circumferentially surrounds at least a portion of the inner casing;
a coupler ring;
an end cap; and
a brazed area on the inner casing, the outer casing, the coupler ring, or the end cap.
